(19) United States
(12) Patent Application Publication
(10) Pub. No.: US 2003/0172780 A1
(43) Pub. Date: Sep. 18, 2003

(54) Multipurpose angular ratchet extension

(76) Inventor: Paul B. Newell, Tallahassee, FL (US)

Correspondence Address: Carnes, Cona & Dixon, Innovation Park, 1673 West Paul Dirac Drive, Tallahassee, FL, 32310-3763, US

(21) Appl. No.: 10/100,585

(22) Filed: Mar. 18, 2002

(51) Int. Cl. B25B 17/00

(52) U.S. Cl. 81/57.29

(57) ABSTRACT

The present invention is a wrench device designed and configured to be utilized in tight and awkward spots. In order to achieve this configuration, the present invention is a tool that is compact in size and one that includes interchangeable socket heads. As such, the present invention comprises a first section and a second section. The first section includes a shaft having a first end and a second end. Located at the first end in a universal receiving member for receiving a ratchet. Located at the second end is a bearing. A worm gear is secured to the shaft and is located between the first end and second end. Coupled to the worm gear is a drive gear. Centrally located in the drive gear is a housing. The housing includes a receptacle for removably receiving sockets. A bearing is secured to the drive gear. The bearings are secured to a housing that covers and protects the components and includes an opening for exposing and providing access to the receptacle.

### BACKGROUND OF THE INVENTION

1. Field of the Invention

The present invention relates generally to an angular ratchet extension tool and more particularly to an angular ratchet extension tool having interchangeable socket heads and is adapted to reach awkward and tight locations so as to allow for the successful consequence of a task by utilizing the present invention.

2. Description of the Prior Art

Wrenches are known tools that are widely utilized and are indispensable in any mechanical field. There are a plethora of tools having a plurality of configurations that are specifically designed that address a particular problem.

Ratchet devices can be as simple as the tool disclosed in U.S. Pat. No. 2,474,402 issued to Napier. In this patent there is disclosed a wrench that is specifically designed that improves the manner for easing and facilitating the mounting and dismounting of the head of the wrench. In order to address this need, the disclosed wrench includes a rotatable head coupled to a handle. The coupling occurs via the use of ratchet teeth. A pair of pawls is located on the handle and is pivotally mounted thereto to provide engagement and communication to the ratchet teeth. In this configuration as the user pivots the handle, the pawls move the head to inherently move the socket. Though successful, this tool would not enable the user to adequately utilize the tool in an awkward and tight spot.

To address the issue of utilizing a tool in awkward and difficult to reach places, a wrench device in disclosed in U.S. Pat. No. 5,231,903 issued to Bockman, Jr. In this patent there is disclosed a ratchet that is ideally suited for tight spot areas by providing a wrench with a unitary floating pawl. This provides for a slidable rotation within the wrench body, yet does not offer any means of interchanging the head.

Though many wrenches exists, what is still needed is a device that is compact in size and one that will allow the user to successful torque action, even in an awkward and tight spot. To add to the versatility, this wrench device should be equipped with interchangeable heads so as to adapted to be used with any size nut or bolt. Such a device should be efficient and substantially traditional in appearance so as to provide for a final product that is simple in design and structure and which will prove successful in achieving the desired results.

As will be seen, the present invention achieves its intended purposes, objectives and advantages by accomplishing the needs as identified above, through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention is a wrench device design and configured to be utilized in tight and awkward spots. In order to achieve this configuration, the present invention is a tool that is compact in size and one that includes interchangeable socket heads. As such, the present invention comprises a first section and a second section. The unit will include means for receiving a socket. The second section is in communication with the first section and will receive a plurality of removably socket heads of various diameter sizes. For protecting the various components of the first and second sections, a housing is provided.

Since the first section is designed to receive a conventional ratchet it includes a first end having coupling capabilities for removably receiving the ratchet and a second end that is coupled to the second section. This coupling occurs via the use of a worm gear that is in communication with a drive gear of the second section.

Secured to the receiving end is a drive shaft. The drive shaft will maintain the receiving end and will also include at least one bearing. The bearing located on the drive shaft will render rotation of the shaft while preventing rotation of the housing.

The drive gear is in communication with the worm gear so that when the worm gear rotates, due to the rotation of the ratchet, the drive gear will also rotate. Centrally secured to the drive gear, and partial exposed, is the socket housing. The socket housing includes a hexagonal shaped opening that will removably receive sockets. The use of removable sockets provides a unit that will be adapted to receive any size bolt. The sockets are secured via a locking mechanism, which includes a ball bearing located within the opening and at least one dimple located exteriorly in each socket head.

A plurality of socket heads is provided. Each socket is appropriately sized for receiving the head of a conventional bolt and thus is include a plurality of sizes. Extending through each wall of the socket is a dimple. The dimples are adapted to be received the ball bearing located within the opening. Having a dimple on each side of the socket heads provides for locking to occur regardless of how the socket is placed within the opening. Inherently providing for an easy and efficient means of installing and removing the desirable socket. Optionally, at least one dimple can be located within the walls of the opening and each exterior wall of the socket head can include the ball bearing.

Due to the use of the warm gear and the use of the drive gear provides an assembly wherein the receiving end is perpendicularly located with respect to the ratchet receiving end as well as being on a different plane. This type of configuration is ideal for providing a tool having a means of removing or loosening bolts which are located in a tight and awkward spot.

In essence, the present invention provides for quick and efficient movement of the socket connection as well as provides for a tool that will adequately and efficiently enable a user to operate a ratchet for removing a desirable bolt. Due to its compact size, this product is ideally suited for tight and awkward areas and will reduce, if not eliminate the difficulties and frustrations generally associated when working in that type of environment.

Accordingly, it is an object of the present invention to provide for a ratchet extension tool device that is simple to use, efficient in utilization and one that will overcome the deficiencies, shortcomings, and drawbacks of prior ratchet tool devices and methods thereof.

It is another object of the present invention to provide for a ratchet extension tool device that can safely, quickly, and efficiently be used in combination with a conventional wrench or ratchet to turn a socket connection or the extension to the socket.

Still a further object of the present invention, to be specifically enumerated herein, is to provide a ratchet extension tool in accordance with the preceding objects and which will conform to conventional forms of manufacture, be of simple construction and easy to use so as to provide a device that would be economically feasible, long lasting and relatively trouble free in operation.

Although there have been other inventions related to ratchet wrenches extension tools, none of the inventions have become sufficiently compact, low cost, and reliable enough to become commonly used. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the invention defined by the claims taken in conjunction with the accompanying drawings.

### BRIEF DESCRIPTION OF THE DRAWING

FIG. 1 is a top view of the ratchet extension tool device of the present invention.

FIG. 2a is a perspective front view of the components of the ratchet extension tool device of the present invention, excluding the housing.

FIG. 2b is a perspective rear view of the components of the ratchet extension tool device of the present invention, excluding the housing.

FIG. 2c is a perspective front view of the components of the ratchet extension tool device of the present invention, illustrating a universal receptacle.

FIG. 3a is a cross-sectional view of the present invention taken along lines 3a-3a of FIG. 1.

FIG. 3b is a cross-sectional view of the present invention taken along lines 3b-3b of FIG. 1.

FIG. 4a is a perspective view of an example of the socket head that is used with the ratchet extension tool device of the present invention.

FIG. 4b is a perspective view of an alternative example of the socket head that is used with the ratchet extension tool device of the present invention.

Similar reference numerals refer to similar parts throughout the several views of the drawings.

### DESCRIPTION OF THE PREFERRED EMBODIMENT

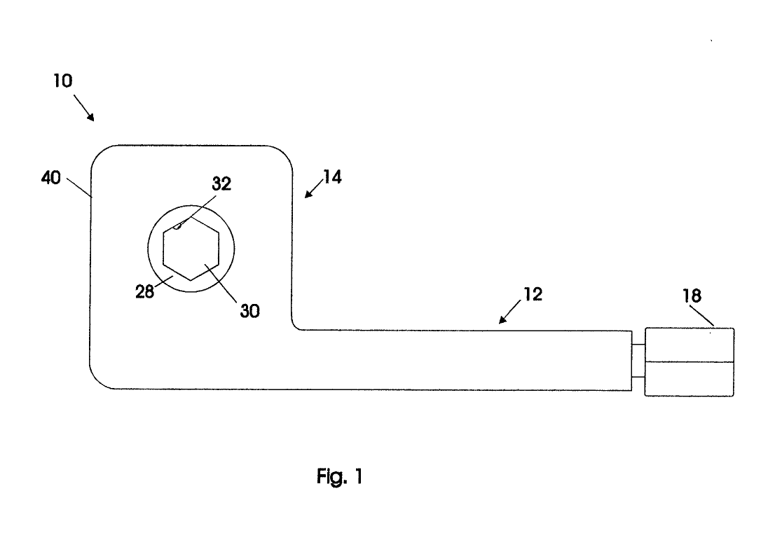

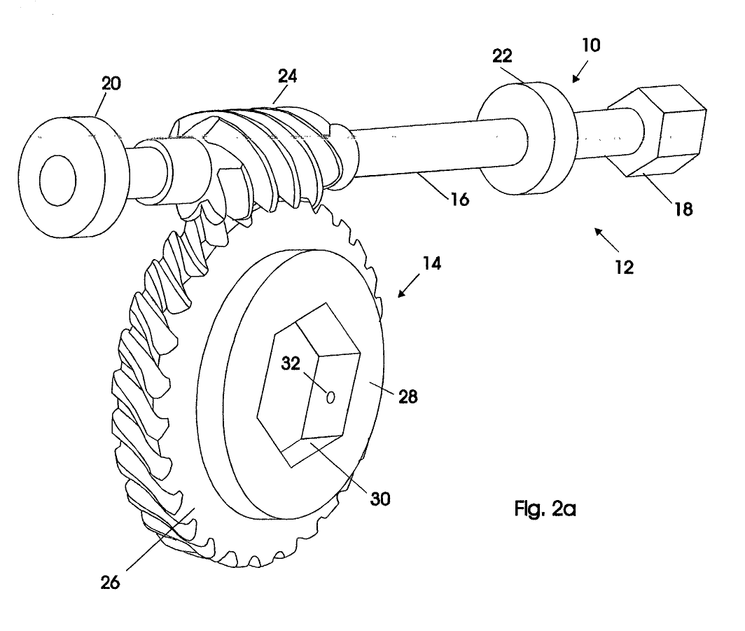

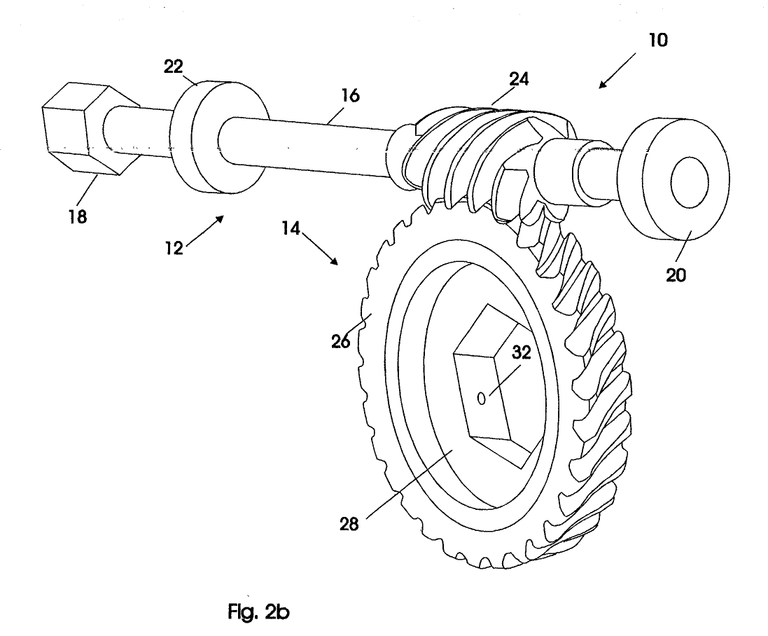

As seen in the drawings, in particular to FIGS. 1-2c there is shown a racket extension tool device, denoted by reference numeral 10, that is designed and configured to adequately and efficiently remove a bolt from any location, even in tight and hard to reach places. The present invention provides a tool that will enable the use of a conventional ratchet and includes uniquely designed socket head that enable quick and easy removal of bolts regardless of there location.

In order to provide for such a configuration, as seen in FIGS. 1-2c, the present invention 10 comprises a first section 12 and a second section 14. This first section being in communication with the second section perpendicularly. The first section 12 includes a drive shaft 16 having a first end and a second end. Secured to the first end is a receiving member 18. This receiving member 18 is conventional and universal in shape so as to provide for a unit that will removably accept a conventional ratchet, universal swivel joint or the like. Located at the second end of the drive shaft is a bearing 20. An optional second bearing 22 can be located in proximity to the first end. This will provide for a more controlled and smoother rotational movement of the first section and second section of the present invention. Secured to the drive shaft 16 in proximity to the second end is a worm gear 24.

The second section 14 comprises a drive gear 26. The drive gear is in communication with the worm gear 24. This provides for the drive gear to be located below the worm gear. Such a configuration provides for a perpendicular arrangement, yet one that is not on the same plane. Thereby, rotation of drive shaft 16 will cause the rotation of the worm gear 24, which inherently causes the rotation of the drive gear 26. This drive gear 26 includes a central opening. Secured to the opening is the socket housing 28. The socket housing can be designed to extend outwardly from the central opening of the gear, as illustrated in the drawings or optionally, can be designed to be flushed with the outer surface of the drive gear 24.

Regardless of the configuration, the socket housing 28 includes a central receptacle 30a and 30b. This receptacle can include any shape or configuration, as seen in the drawings. To enable conventional sockets to be used with the present invention, the receptacle 30a can include a universally shaped opening, such as the square shape as illustrated in FIG. 2c. This square opening will allow for conventional sockets to be utilized with the present invention. A locking system is provided within the central receptacle 30a for enabling the sockets to be locked and secured therein. As seen in the drawings, the locking system includes the use of ball bearings 32. The ball bearings will correspond with openings or dimples that are generally found on conventional sockets. Thereby enabling any type of socket to be secured thereto.

Optionally, the receptacle can include a unique hexagonal opening 30b. This opening will be designed to receive exteriorly hexagonal shaped sockets. Thereby providing for the sockets to be specifically designed for this particular receptacle. This hexagonal opening 30b also includes a locking mechanism that is adapted to mate with the exterior mating locking mechanism. In the preferred embodiment, the locking mechanism is a ball bearing that is designed to receive a dimple, groove or the like.

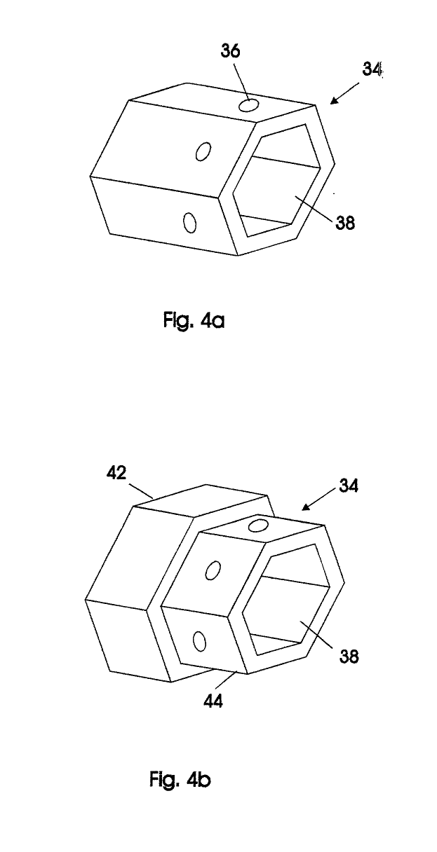

Accordingly, the present invention also includes a plurality of sockets. By way of example only one socket 34 will be illustrated, since each socket will be substantially the same shape, its differences residing in the opening of the socket which will receive a bolt head. This varying size of opening is known in the art. As seen in the drawings, in particular to FIG. 4a, therein shown a hexagonal shaped socket that is designed and configured to be received within the hexagonal opening. Located on each exterior side of the socket is a dimple or groove 36 that is designed to receive the ball bearing 32 of the opening within the drive gear 26. A central hexagonal shaped opening is located within the socket for receiving a conventional bolt. This central opening 38 will varying in size so that the desired and appropriately sized socket is used. In each set of sockets, the outer size will remain constant.

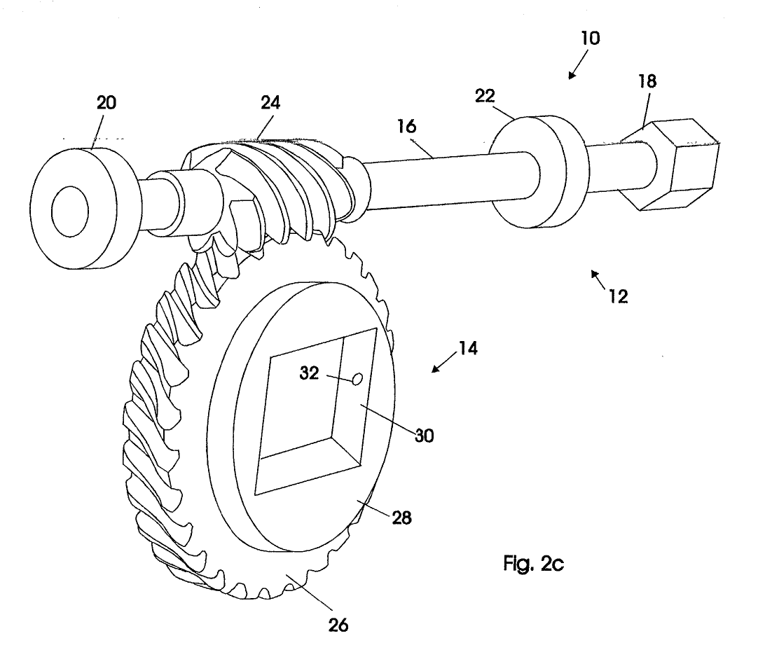

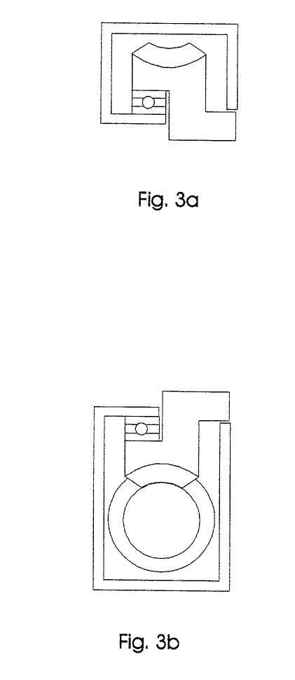

Alternatively, the socket can include an alternative configuration. This configuration is shown in FIG. 3b. As seen the docket 34 includes a front portion 40 and a rear portion 42. The front portion 40 is stepped down from the rear portion 42 and this front portion includes the locking system exteriorly secured thereto. This provides for the rear portion 42 to extend slightly outwardly from the housing 28 so as to receive the head of the bolt. This type of socket may be desirable dependent upon the location of the bolt.

It is noted that the locking system can be any conventional system, such as the locking system as defined above can be reversed. This reversal will provide for the ball bearing to be exteriorly located on the socket while the interior of the receptacle 30 would include at least one dimple.

Other configurations can be utilized for the locking system of the present invention, for example, the grooves can have a particular shape, such as a T-shape and flanges having the shape of the grooves can extend outwardly from the respective member. This will provide for the socket to be slideably located within the receiving member and provide for the socket to be removably secured thereto.

To protect the components of the present invention and to secure the drive gear, a housing 40 is provided. The housing encompasses the components and provides for the drive shaft 16 to be secured to the housing via the bearings 20 and 22. The housing includes an opening for exposing the receptacle for the socket. The drive gear 26 is secured to the housing via a bearing 44 that is secured to the hub of the housing 28. Thus bearing 44 provides for the drive gear to secured while still enabling rotation of the housing 28. A second bearing, not illustrated, can be located on the opposite or rear side of the drive gear and secured thereto.

In essence to utilize the present invention, the user places the desired socket within the receptacle 30 of the drive gear 26. The desired socket is selected via the size of the bolt to be removed. The socket is placed within the receptacle and the socket is then placed on the bolt. The ratchet is then secured to the first end of the shaft 16. Or optionally a universal swivel joint is secured thereto and then the ratchet is secured to the swivel joint. Once one, the ratchet is pivoted downward to provide for the drive shaft 16 to rotate. This causes the rotation of the housing, which inherently provides for the socket to rotate. The rotation will enable the attachment or removal of the desired bolt.

While the invention has been particularly shown and described with reference to an embodiment thereof, it will be understood by those skilled in the art that various changes in form and detail may be made without departing from the spirit and scope of the invention.

I claim:

1. A tool assembly comprising:
a first section and a second section;
said first section includes a shaft having an first end and a second end;
a universal receiving member is located at said first end;
a bearing is secured to said second end;
a worm gear is secured to said shaft and is located between said first end and said second end;
said second section includes a drive gear is in communication to said worm gear;
a socket housing is centrally secured to said drive gear and said housing includes a receptacle;
a second bearing is secured to said drive gear;
a locking assembly is located within said receptacle; and
a housing protects and shields said first section and said second section and said housing includes an opening for exposing said receptacle.

2. A tool assembly as in claim 1 wherein said receptacle removably receives a single socket from a plurality of sockets, said plurality of sockets include an outer size same in dimension and an inner core varying in size for each socket.

3. A tool assembly as in claim 2 wherein each of said plurality of sockets include a mating locking assembly exteriorly located thereon and said mating locking assembly is adapted to removable lock with said locking assembly located within said receptacle.

4. A tool assembly as in claim 1 wherein said receptacle includes a square-like configuration for providing a universal receptacle.

5. A tool assembly as in claim 1 wherein said socket housing extends outwardly from said drive gear for forming a hub.

6. A tool assembly as in claim 1 wherein said socket housing extends outwardly from a side of said drive gear for forming a hub and said socket housing being recess inward from a opposite side from said side.

7. A tool assembly as in claim 2 wherein said receptacle includes a hexagonal shape and each of said plurality of sockets include an exterior hexagonal shape for being received and secured in said receptacle.

8. A tool assembly as in claim 7 wherein each of said plurality of sockets further include a front section and a rear section, said front section being sized for said receptacle and said rear section being larger in size than said front section.

9. A tool assembly as in claim 7 wherein the locking assembly comprises at least one ball bearing secured to said receptacle and exteriorly located on each wall of each socket is a dimple.

10. A tool assembly comprising:
a shaft having an first end and a second end;
a universal receiving member is located at said first end;
a bearing is secured to said second end;
a worm gear is secured to said shaft and is located between said first end and said second end;
a drive gear is in communication to said worm gear;
a socket housing is centrally secured to said drive gear and said housing includes a receptacle;
a second bearing is secured to said drive gear; and
a housing protects and shields said first section and said second section and said housing includes an opening for exposing said receptacle.

11. A tool assembly as in claim 10 wherein said receptacle includes a square-like configuration for providing a universal receptacle.

12. A tool assembly as in claim 10 wherein said receptacle includes a hexagonal configuration.

13. A tool assembly as in claim 12 wherein said receptacle removably receives a single socket from a plurality of sockets, said plurality of sockets include an outer size same in dimension and an inner core varying in size for each socket and said plurality of sockets include an exterior hexagonal shape for being received and secured in said receptacle.

14. A tool assembly as in claim 10 wherein said socket housing extends outwardly from a side of said drive gear for forming a hub and said socket housing being recess inward from a opposite side from said side.

15. A tool assembly as in claim 13 wherein each of said plurality of sockets further include a front section and a rear section, said front section being sized for said receptacle and said rear section being larger in size than said front section.
